(19) United States
(12) Patent Application Publication
(10) Pub. No.: US 2024/0429524 A1
(43) Pub. Date: Dec. 26, 2024

(54) BATTERY APPARATUS

(71) Applicants: HYUNDAI MOTOR COMPANY, Seoul (KR); KIA CORPORATION, Seoul (KR); SEBANG LITHIUM BATTERY CO., LTD., Anyang-si (KR)

(72) Inventors: Sung In BAEK, Hwaseong-si (KR); Hee Gun YANG, Seongnam-si (KR); Kang Woo BAE, Suwon-si (KR); In Hwan BAE, Anyang-si (KR); Young Jin KIM, Anyang-si (KR); Sin Wook KIM, Anyang-si (KR); Dae Han JANG, Anyang-si (KR)

(21) Appl. No.: 18/540,344

(22) Filed: Dec. 14, 2023

(30) Foreign Application Priority Data
Jun. 26, 2023 (KR) 10-2023-0081769

(51) Int. Cl. H01M 50/244; H01M 50/204; H01M 50/256

(52) U.S. Cl. CPC H01M 50/244; H01M 50/204; H01M 50/256

(57) ABSTRACT

A battery apparatus includes a plurality of batteries, an upper case including fixing parts respectively protruding in left and right directions from both side surfaces thereof, each of the fixing parts having a catching protrusion protruding from an end portion thereof, and a handle including coupling parts coupled to the respective fixing parts at both ends thereof.

### CROSS-REFERENCE TO RELATED APPLICATION

The present application claims the benefit under 35 USC § 119 (a) of Patent Application No. 10-2023-0081769, filed on Jun. 26, 2023, in Korea, the entire disclosure of which is incorporated herein by reference for all purposes.

### TECHNICAL FIELD

The present disclosure relates to a battery apparatus.

### BACKGROUND

A battery module used in a vehicle may include a handle for ease of transportation. For example, the battery module may have a single cover structure with the handle on the top. The handle is shaped to give a sense of stability to a user's hand and to avoid strain on the hand.

When the battery module is transported, in case the transportation path is a stairway or an inclined place, the battery module may not be leveled and transported in an inclined state. In this case, a locking protrusion of the handle moves due to the self-weight of the battery module. When the locking protrusion continues to move, the handle may separate from a cover of the battery module, which may cause the battery module to fall to be broken or cause personal injury. In some cases, a gap or clearance may be present in a coupling structure between the handle and the cover of the battery module, which may cause noise due to vibration inside the vehicle.

### SUMMARY

The present disclosure describes a battery apparatus in which a handle can be easily coupled to an upper case.

According to one aspect of the subject matter described in this application, a battery apparatus includes an upper case including fixing parts that protrude in left and right directions from side surfaces of the upper case, respectively, where each of the fixing parts includes a catching protrusion that protrudes from an end portion thereof. The battery apparatus further includes a handle including coupling parts that are disposed at ends of the handle and coupled to the fixing parts, respectively.

Implementations according to this aspect can include one or more of the following features. For example, the upper case can further include a seating surface that supports the handle disposed at a fixed position, a recessed surface recessed downward from a portion of the seating surface, and a limiting surface that is disposed below the fixing parts and perpendicular to the seating surface. In some implementations, the handle can further include a grip that connects between the coupling parts.

In some examples, the grip can have a curved shape corresponding to a shape of an outermost surface of the upper case. In some examples, the grip can include a protrusion that has a bar-shape and protrudes downward toward the upper case.

In some implementations, each of the coupling parts can define a connection hole coupled to one of the fixing parts, where each of the coupling parts includes a plurality of inner protrusions that protrude from an inner circumferential surface of the connection hole toward a central axis of the connection hole. In some examples, each of the plurality of inner protrusions can have a shape corresponding to a shape of the catching protrusion.

In some implementations, each of the plurality of inner protrusions can be configured to face the catching protrusion based on one of the coupling parts being coupled to one of the fixing parts, and to be restricted by the catching protrusion in a left-right direction based on the handle being rotated relative to the upper case.

In some implementations, each of the coupling parts can further include a fixing protrusion configured to generate frictional force with respect to a surface of the upper case and to reduce a gap between the handle and the upper case, and a rotating protrusion configured to restrict the handle from rotating relative to the upper case. In some examples, a cross-sectional shape of the rotating protrusion defines two or more curvatures.

In some implementations, after the handle is coupled to the upper case, no or a minimal clearance may be present between the upper case and the handle, which can help reduce or eliminate vibration and noise.

### BRIEF DESCRIPTION OF THE DRAWINGS

FIG. 1 is a perspective view illustrating an example of a battery apparatus.

FIG. 2 is a perspective view of the battery apparatus in which a handle is separated.

FIG. 3 is a perspective view showing in detail an example of a coupling part of the handle.

FIG. 4 is a partially enlarged view showing an example of a coupling structure between a fixing part and the coupling part of the battery apparatus.

FIG. 5 is a diagram illustrating an example of using the handle of the battery apparatus.

### DETAILED DESCRIPTION

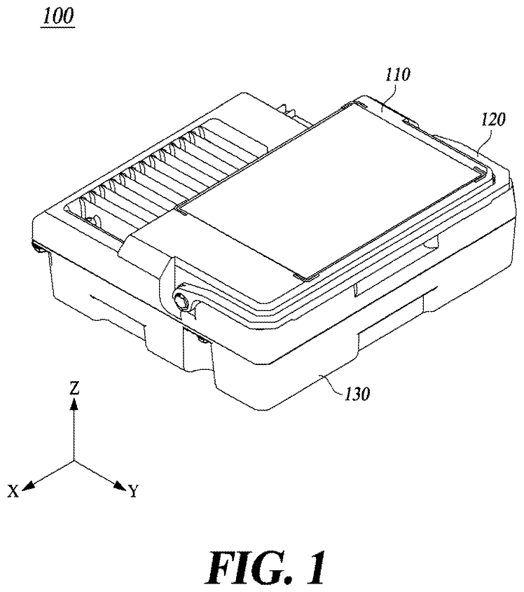

FIG. 1 is a perspective view illustrating an example of a battery apparatus.

In some implementations, referring to FIG. 1, a battery apparatus 100 includes all or at least some of an upper case 110, a handle 120, and a lower case 130.

For example, the upper case 110 is disposed on top of the battery apparatus 100. The upper case 110 can protect units disposed inside the battery apparatus 100 from shock transmitted from above of the battery apparatus 100.

The lower case 130 is disposed at the bottom of the battery apparatus 100. The lower case 130 is coupled to the upper case 110.

In some examples, a heat sink can be disposed on one surface of the upper case 110.

The heat sink dissipates heat generated inside the battery apparatus 100 to the outside. The heat sink may be disposed at the lower case 130.

In some implementations, the handle 120 can include a coupling part 230 and a grip 240. The handle 120 is coupled to the upper case 110. A user may carry the battery apparatus 100 using the handle 120.

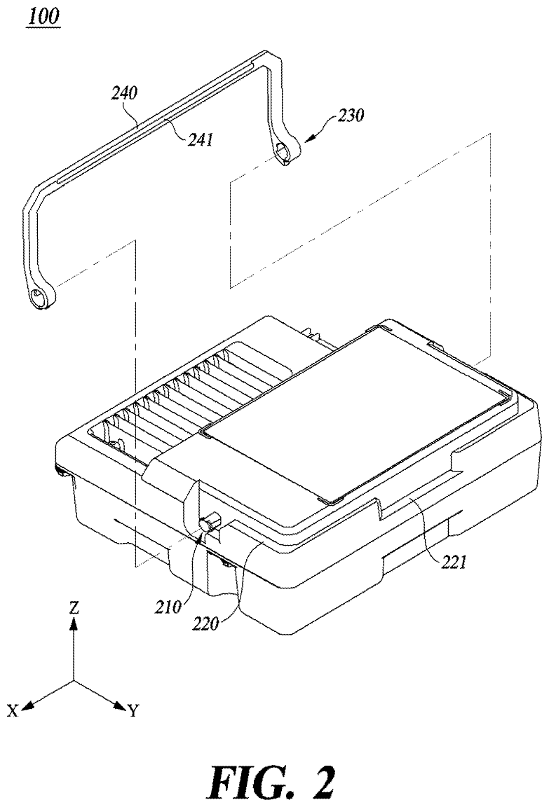

FIG. 2 is a perspective view of the battery apparatus in which the handle is separated.

In some implementations, referring to FIGS. 1 and 2, the upper case 110 includes fixing parts 210, a seating surface 220, and a recessed surface 221.

The fixing parts 210 can protrude from both side surfaces of the upper case 110 in left and right directions, respectively. The fixing parts 210 include a first fixing part and a second fixing part. The first fixing part can protrude toward the left direction of the upper case 110, and the second fixing part can protrude toward the right direction of the upper case 110. For example, the left direction refers to the positive x-axis direction, and the right direction refers to the negative x-axis direction. The fixing part 210 is coupled with the handle 120. A cross-sectional shape of the fixing part 210 may have a circular shape, an elliptical shape, or a rectangular shape. In other implementations, the cross-sectional shape of the fixing part 210 is not limited thereto.

The seating surface 220 refers to one surface on the upper case 110 to which the handle 120 is fixed. The seating surface 220 is provided so that the handle 120 can be seated on the upper case 110. Accordingly, the seating surface 220 is formed to correspond to a shape of the handle 120.

The recessed surface 221 is defined at the seating surface 220. The recessed surface 221 defines a space between the handle 120 and the seating surface 220, so that the user can easily grip the handle 120 when rotating the handle 120 from a fixed position. Therefore, when gripping the handle 120 fixed in the fixed position, the user can grip the handle 120 by putting a finger in the recessed surface 221 disposed between the upper case 110 and the grip 240. For instance, the fixed position can be a position where the handle 120 is fixed to the seating surface 220.

A material of the handle 120 may be, for example, polypropylene.

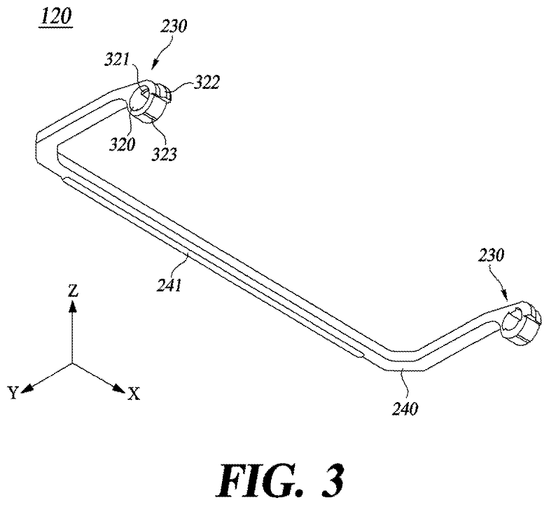

FIG. 3 is a perspective view showing in detail the coupling part of the handle.

Referring to FIGS. 1 to 3, the grip 240 is provided so that a use can easily carry the battery apparatus 100 when carrying the battery apparatus 100. The grip 240 may include a hook. When carrying the battery apparatus 100, the hook on the grip 240 may be connected to a mechanical device or the like. The hook may be disposed at the center of the grip 240. A protrusion 241 is disposed on a lower surface of the grip 240 to protrude therefrom.

When a user grips the grip 240, the protrusion 241 can improve grip feel. The protrusion 241 protrudes downward in a bar shape.

The coupling part 230 includes a connection hole 320, an inner protrusion 321, a rotating protrusion 322, and a fixing protrusion 323.

The connection hole 320 is coupled to the fixing part 210. The inner protrusion 321 is disposed on an inner surface of the connection hole 320. The inner protrusion 321 protrudes toward of a central axis of the connection hole 320. The inner protrusion 321 may include two or more protrusions. A shape of the inner protrusion 321 corresponds to a shape of a catching protrusion 311 to be described later. Specifically, when the handle 120 rotates, the shape of the inner protrusion 321 and the shape of the catching protrusion 311 correspond to each other so that the coupling part 230 may not separate from the fixing part 210.

In some examples, the rotating protrusion 322 can be disposed on an outer surface of the coupling part 230. The rotating protrusion 322 can restrict rotation of the handle 120. For example, the rotation of the rotating protrusion 322 can be restricted by a limiting surface 312 to be described later. The rotating protrusion 322 can have a cross-sectional shape with two or more curvatures. Therefore, even if a part of the rotating protrusion 322 is damaged or deformed, rotation of the handle can be restricted using at least one rotating protrusion.

In some implementations, the fixing protrusion 323 can be disposed on the outer surface of the coupling part 230. For example, the fixing protrusion 323 can protrude from the outer surface of the coupling part 230. The fixing protrusion 323 can help eliminate a gap or clearance between the upper case 110 and the handle 120 when the handle 120 rotates. The fixing protrusion 323 generates frictional force with one surface of the upper case 110. The handle 120 may maintain a rotated state by a predetermined angle due to the frictional force between the fixing protrusion 323 and the upper case 110. For example, the one surface of the upper case 110 includes a flat surface perpendicular to the limiting surface 312.

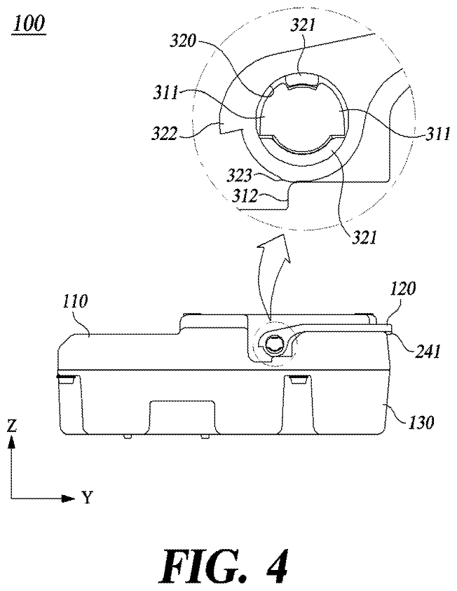

FIG. 4 is a partially enlarged view showing a coupling structure between the fixing part and the coupling part of the battery apparatus.

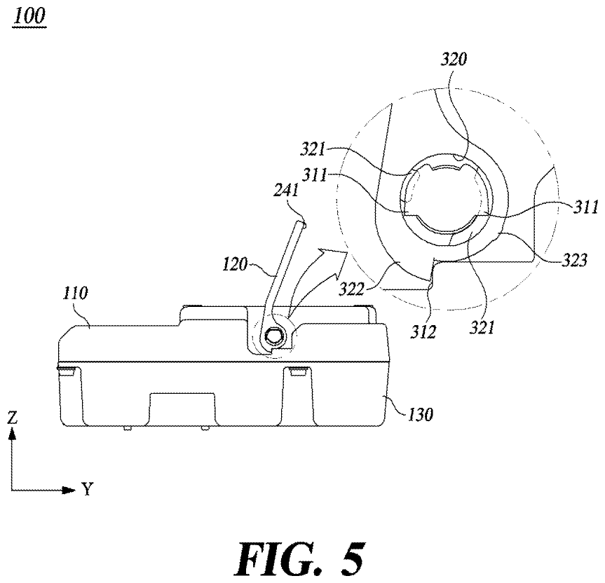

FIG. 5 is a diagram illustrating an example of using the handle of the battery apparatus.

Referring to FIGS. 3 to 5, the fixing part 210 includes catching protrusions 311. The catching protrusions 311 may include two or more protrusions. The catching protrusions 311 can partially protrude from an end portion of the fixing part 210 in an outer diameter direction. For example, the outer diameter direction refers to an outer diameter direction based on a central axis of the fixing part 210 on a plane defined by the z-axis and the y-axis. The shape of the catching protrusion 311 corresponds to the inner protrusion 321.

After the handle 120 is coupled to the upper case 110, the catching protrusion 311 and the inner protrusion 321 can reduce or eliminate a gap or clearance in the coupling structure between the handle 120 and the upper case 110.

The upper case 110 includes a limiting surface 312. The limiting surface 312 can limit the rotation angle of the handle 120. The limiting surface 312 can be recessed from one surface of the upper case 110. For example, the limiting surface 312 defines a vertical plane so that the handle is rotatable from 0° to 90°. For example, the vertical surface refers to a surface in the z-axis direction perpendicular to the y-axis direction. The limiting surface 312 can be disposed below the fixing part 210. In some examples, the limiting surface 312 can be defined along a rotation radius of the rotating protrusion 322. Accordingly, when the handle 120 rotates, the rotating protrusion 322 contacts the limiting surface 312 to thereby restrict the rotation of the handle 120.

When the handle 120 rotates, the catching protrusion 311 and the inner protrusion 321 cross each other. Therefore, while the handle 120 rotates from the fixed position or maintains the rotated state, the coupling part 230 may not separate from the fixing part 210.

What is claimed is:

1. A battery apparatus comprising:
an upper case comprising fixing parts that protrude in left and right directions from side surfaces of the upper case, respectively, wherein each of the fixing parts comprises a catching protrusion that protrudes from an end portion thereof; and
a handle comprising coupling parts that are disposed at ends of the handle and coupled to the fixing parts, respectively.

2. The battery apparatus of claim 1, wherein the upper case further comprises:
a seating surface that supports the handle disposed at a fixed position;
a recessed surface recessed downward from a portion of the seating surface; and
a limiting surface that is disposed below the fixing parts and perpendicular to the seating surface.

3. The battery apparatus of claim 1, wherein the handle further comprises a grip that connects between the coupling parts.

4. The battery apparatus of claim 3, wherein the grip has a curved shape corresponding to a shape of an outermost surface of the upper case.

5. The battery apparatus of claim 3, wherein the grip comprises a protrusion that has a bar-shape and protrudes downward toward the upper case.

6. The battery apparatus of claim 1, wherein each of the coupling parts defines a connection hole coupled to one of the fixing parts, and
wherein each of the coupling parts comprises a plurality of inner protrusions that protrude from an inner circumferential surface of the connection hole toward a central axis of the connection hole.

7. The battery apparatus of claim 6, wherein each of the plurality of inner protrusions has a shape corresponding to a shape of the catching protrusion.

8. The battery apparatus of claim 6, wherein each of the plurality of inner protrusions is configured to:
face the catching protrusion based on one of the coupling parts being coupled to one of the fixing parts; and
be restricted by the catching protrusion in a left-right direction based on the handle being rotated relative to the upper case.

9. The battery apparatus of claim 1, wherein each of the coupling parts further comprises:
a fixing protrusion configured to generate frictional force with respect to a surface of the upper case and to reduce a gap between the handle and the upper case; and
a rotating protrusion configured to restrict the handle from rotating relative to the upper case.

10. The battery apparatus of claim 9, wherein a cross-sectional shape of the rotating protrusion defines two or more curvatures.
